(19) United States
(12) Patent Application Publication
(10) Pub. No.: US 2017/0300684 A1
(43) Pub. Date: Oct. 19, 2017

(54) METHOD OF AUTHENTICATING A USER, CORRESPONDING TERMINALS AND AUTHENTICATION SYSTEM

(71) Applicant: GEMALTO SA, Meudon (FR)

(72) Inventors: Julien GLOUSIEAU, Gemenos Cedex (FR); Abdellah EL MAROUANI, Gemenos Cedex (FR)

(73) Assignee: GEMALTO SA, Meudon (FR)

(21) Appl. No.: 15/511,961

(22) PCT Filed: Sep. 14, 2015
(86) PCT No.: PCT/EP2015/070928

§ 371 Date: Mar. 16, 2017

(30) Foreign Application Priority Data
Sep. 17, 2014 (EP) 14306437.6

(51) Int. Cl. G06F 21/34; G06F 21/36

(52) U.S. Cl. CPC G06F 21/34; G06F 21/36

(57) ABSTRACT

A method of authenticating a user at a first terminal or a remote server connected to the first terminal, the authentication including inputting a code into the first terminal by the user and in comparing this code with a confidential personal code of the user, the confidential personal code comprising symbols to be input successively by the user into the first terminal, the method including transmitting from the first terminal to a second terminal belonging to the user a disordered series of symbols, a subset of which constitutes the confidential personal code, displaying on a screen of the second terminal the disordered series of symbols in a grid, called the second grid, each symbol of the series being contained in a box of the second grid, inputting by the user on the first terminal, the confidential personal code into a grid, called the first grid, at the corresponding locations of the symbols of the confidential personal code in the second grid, and verifying, at the first terminal or the remote server, that the series of symbols Input by the user is identical to the confidential personal code, so as to authenticate the user.

The present invention relates to the field of telecommunications and relates to a method for entering a confidential personal code, for example a PIN code, in a terminal, in a non-secure environment. The terminal is for example a terminal at a sales outlet, a ticket dispenser, a smartphone or a computer tablet connected to an internet site requesting the user to authenticate himself.

For this authentication, the user conventionally enters a confidential personal code on a touch screen displaying digits 0 to 9.

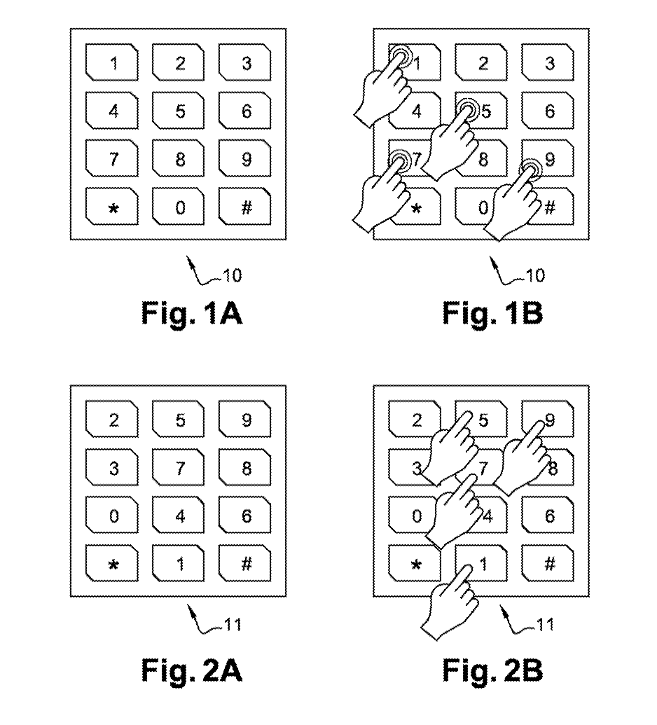

FIG. 1A shows such a touch screen.

A touch screen 10 displays a grid of twelve boxes in which the digits 0 to 9 and the characters * and # are displayed. Here the digits are ordered in the grid, that is to say they follow each other logically speaking (1 to 3 in the first row, 4 to 6 in the second row, 7 to 8 in the third row and 0 in the central position in the last row). The user is then invited to enter his confidential personal code.

To do this, as shown in FIG. 1B, the user presses successively with one of his fingers on the keys displaying the symbols of his confidential personal code. Here his confidential personal code is for example 1759 and the user presses successively on the keys 1, 7, 5 and then 9.

The code entered by the user is then compared with the confidential personal code of the user. This confidential personal code may be included in a chip card of the user, this chip card previously having been inserted in a reader cooperating with a terminal. The confidential personal code may also be stored at a remote server connected to the terminal.

Whether at the terminal or the remote server, the authentication of the user is positive if the code entered by the user corresponds to the confidential personal code of the card of the user or to the one stored at the remote server (typically in order to be authenticated with an internet site, for example with a banking site) and negative in the contrary case.

The drawback of the solution in FIGS. 1A and 1B is that a malevolent person may, after the user has departed, observe at what locations on the touch screen 10 the user placed his finger in order to deduce the code therefrom unambiguously, since the symbols (here digits) displayed are ordered (at the next display of the grid, the symbols 0 to 9 are at the same locations in the grid).

In order to remedy this drawback, mixing the symbols in the grid is known, as shown in FIG. 2A.

FIG. 2A shows a touch screen 11 that as before displays a grid of twelve boxes in which the digits 0 to 9 and the characters * and # are displayed.

Here, unlike FIG. 1A, the symbols (digits) are out of order (mixed) in the grid. As the mixing of the symbols in the grid differs at each display (the symbols are not all at the same locations from one display to another), an ill-intentioned person cannot know the code entered by the user simply by observing the surface of the screen after the user has departed. The user is then invited to enter his confidential personal code, which he does by successively entering the symbols 1, 7, 5 and then 9 (FIG. 2B).

This solution, although very widespread, nevertheless suffers from a major handicap: if an ill-intentioned person observes the user while he is entering his confidential personal code (for example looks over his shoulder), this person takes cognisance of the code and can subsequently use it unknown to the user. The same applies if a camera films the inputting of the symbols by the user or if malware has been installed in the terminal. This software can for example record on which key the user has successively placed his finger and, from knowledge of the arrangement of the symbols in the grid, deduce therefrom the code entered by the user.

The objective of the present invention is in particular to overcome this drawback.

More precisely, one of the objectives of the invention is to provide a method for ensuring the confidentiality of inputting of the symbols constituting a confidential personal code in a grid displayed on a touch screen.

This objective, as well as others that will emerge subsequently, is achieved by means of a method for authenticating a user with a first terminal or a remote server connected to the first terminal, the authentication consisting of the entering of a code in the first terminal by the user and comparing this code with a confidential personal code of the user, the confidential personal code comprising symbols to be entered successively by the user in the first terminal, the method consisting of:
a. transmitting from the first terminal to a second terminal belonging to the user an out-of-order series of symbols, a subset of which constitutes the confidential personal code;
b. displaying on a screen of the second terminal the out-of-order series of symbols in a grid, referred to as the second grid, each symbol in the series being contained in a box of the second grid;
c. the entering, by the user on the first terminal, of the confidential personal code in a grid, referred to as the first grid, at the corresponding locations of the symbols of the confidential personal code in the second grid;
d. checking, at the first terminal or remote server, that the series of symbols entered by the user is identical to the confidential personal code, in order to authenticate the user.

Advantageously, step -a- comprises a step of displaying on a screen cooperating with the first terminal an enciphered image comprising an out-of-order series of symbols a subset of which constitutes the confidential personal code, and step -b- comprises a step of deciphering, by means of the second terminal, the enciphered image by means of a camera provided on the second terminal and a deciphering key.

In another embodiment, step -a- comprises a step of transmission, by a short-distance radio connection or a local-network connection, of the out-of-order series of symbols from the first terminal to the second terminal.

The enciphered image is preferentially a QR code.

The second terminal preferentially consists of a smartphone or smart glasses.

The first terminal is preferentially a banknote dispenser or a retail sales terminal.

The invention also relates to a terminal, referred to as the first terminal, this terminal comprising means for:
a. transmitting, to a second terminal belonging to a user, an out-of-order series of symbols, a subset of which constitutes a confidential personal code of the user;
b. displaying a first virtual grid in which the user can select locations corresponding to locations of symbols displayed in a second grid on the second terminal.

This first terminal advantageously also comprises means for checking that the series of symbols entered by the user in the first virtual grid is identical to the confidential personal code, in order to authenticate the user.

Alternatively, the first terminal also comprises means for transmitting the series of symbols entered by the user in the first virtual grid to a remote server.

The invention also relates to a user terminal, referred to as the second terminal, this second terminal comprising means for:
a. receiving from a first terminal an out-of-order series of symbols, a subset of which constitutes a confidential personal code of the user;
b. displaying, on a screen of the second terminal, the out-of-order series of symbols in a grid, referred to as the second grid, each symbol in the series being contained in a box of the second grid.

Preferentially, the user terminal also comprises means for deciphering an enciphered image displayed on a screen of the first terminal by means of a camera provided on the second terminal and a deciphering key, the deciphered image comprising the out-of-order series of symbols a subset of which constitutes the confidential personal code of the user.

The user terminal preferentially consists of smart glasses.

The invention also relates to a system for authenticating a user with a first terminal or a remote server connected to the first terminal, the authentication consisting of the entering of a code in the first terminal by the user and comparing this code with a confidential personal code of the user, the confidential personal code comprising symbols to be entered successively by the user in the first terminal, this system comprising:
a. means for transmitting from the first terminal to a second terminal belonging to the user an out-of-order series of symbols, a subset of which constitutes the confidential personal code;
b. means for displaying on a screen of the second terminal the out-of-order series of symbols in a grid, referred to as the second grid, each symbol in the series being contained in a box of the second grid;
c. means for entering, by the user on the first terminal, the confidential personal code in a grid, referred to as the first grid, at the corresponding locations of the symbols of the confidential personal code in the second grid;
d. means for checking, at the first terminal or remote server, that the series of symbols entered by the user is identical to the confidential personal code, in order to authenticate the user.

Advantageously, the system also comprises:
a. means for displaying, on a screen cooperating with the first terminal, an enciphered image comprising an out-of-order series of symbols a subset of which constitutes the confidential personal code;
b. means for deciphering, by means of the second terminal, the enciphered image by means of a camera provided on the second terminal and a deciphering key.

Other features and advantages of the invention will emerge from a reading of the following description of two particular embodiments, given by way of explanation and non-limitatively, and the accompanying figures, in which:

FIGS. 1A and 1B depict respectively ordered symbols in a grid displayed on a touch screen and the successive pressing on the symbols constituting a confidential personal code by a user;

FIGS. 2A and 2B show respectively out-of-order symbols in a grid displayed on a touch screen and the successive pressing of the symbols constituting a confidential personal code by a user;

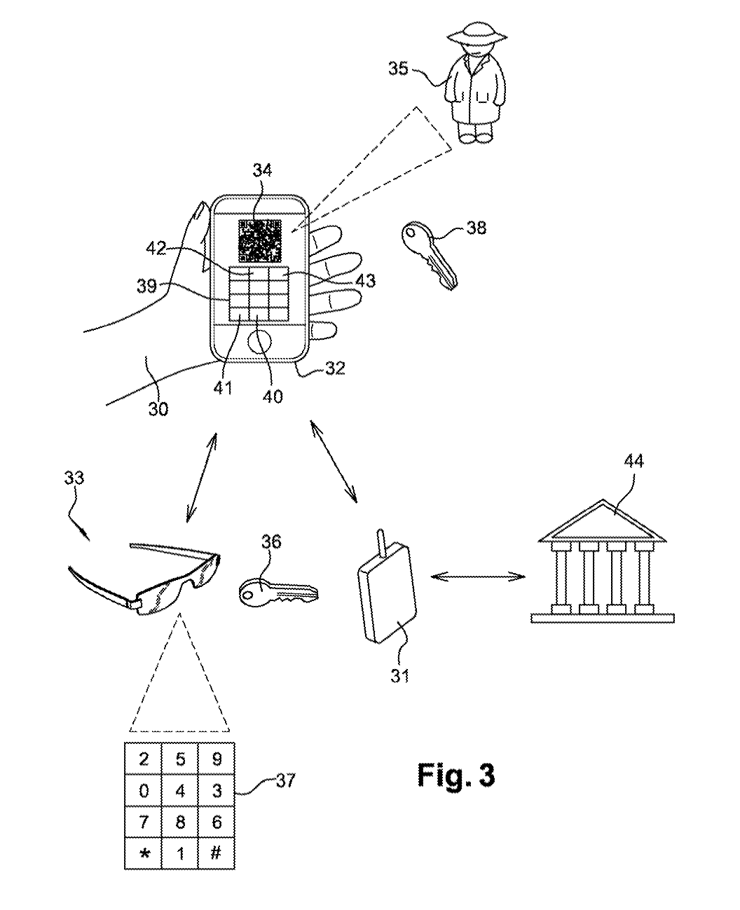

FIG. 3 shows a first embodiment of the invention;

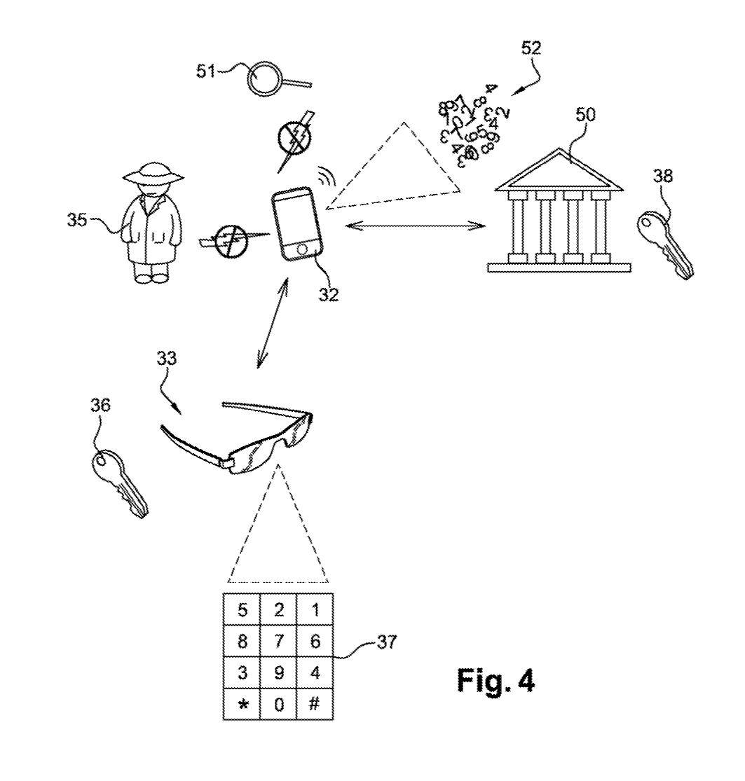

FIG. 4 shows a second embodiment of the invention.

FIGS. 1A to 2B were described previously with reference to the prior art.

FIG. 3 shows a first embodiment of the invention.

In this figure, the authentication of a user 30 with a merchant having an NFC reader 31 is proceeded with (authentication of a user in NFC is required for transaction amounts exceeding a predetermined sum, for example 20 Euros). The user has his smartphone 32 comprising an NFC payment application. The smartphone 32 will hereinafter be referred to as the first terminal and comprises a touch screen enabling the user to enter his confidential personal code after having initially moved his smartphone 32 close to the NFC reader 31 (having carried out a “tap”).

Just as in the prior art, the authentication consists of manually entering a code in the first terminal 32 and comparing this code with a confidential personal code of the user, the confidential personal code comprising symbols to be entered successively by the user in the first terminal.

According to the invention, a second terminal 33 belonging to the user 30 is used. The second terminal 33 is here shown in the form of a pair of smart glasses of the Google Glass type (protected trade mark). Intelligent glasses are an optronic system for displaying information (text, Image, etc.) superimposed on the visual field of the user. The smart glasses 33 may potentially (but not necessarily) be connected to a telecom network (3G/4G) or to a domestic network (via Wi-Fi).

The invention functions as follows, in this first embodiment:

The first terminal 32 generates an enciphered image 34 that is displayed on its screen. The image 34 has been enciphered by means of a key 38. The enciphered image 34 is here a QR code and contains an out-of-order series of symbols a subset of which constitutes the confidential personal code of the user. An ill-intentioned person 35 who sees the screen of the terminal 32 sees only this enciphered image 34 and cannot derive any exploitable information therefrom, since they do not know the key for deciphering the image 34.

On the other hand, the second terminal 33 of the user comprises the enciphering key 36 of the image 34. By means of a camera equipping the second terminal 33 (the smart glasses are provided with cameras), the enciphered image 34 is filmed or a photograph thereof is taken by the second terminal 33. By means of the deciphering key 36 included in the second terminal 33, the image 34 is deciphered and displayed on the screen of this second terminal 33. In the case of smart glasses, an out-of-order series of symbols is displayed on at least one of the lenses of the glasses. In the case of the use of a smartphone provided with a camera (the user holds two smartphones, the one referenced 32 and another), the out-of-order series of symbols is displayed on the screen of the smartphone.

The out-of-order series of symbols is shown placed in a grid referenced 37, referred to as the second grid, in FIG. 3. At least the symbols of the confidential personal code of the user are present in the second grid 37. Here, to take the example of the code 1755 given previously, the symbols are digits (0 to 9). One of the important points is that at least the symbols of the confidential personal code are out of order in the second grid 37, that is to say they are not at the same locations from one authentication to another.

The user, on seeing the second grid 37, knows the locations of the symbols of his code in the second grid 37. He then manually enters the symbols of his confidential personal code in a grid 39, referred to as the first grid, at the corresponding locations of the symbols of his confidential personal code in the second grid 37. By way of example, if his confidential personal code is 1759, he presses successively on the locations referenced respectively 40, 41, 42 and then 43.

In a case where the first terminal 32 is a smartphone, the keypad is a touch pad and there is therefore a display of a virtual grid 39, of the same form as the second grid 37. There is no limitation on the size of the boxes: the boxes may not all be of the same size. The number, thereof is also not limited. There is also no limitation on the form of the boxes, the boxes may be rectangles, circles, squares, diamonds, etc.

Where the first terminal 32 is a payment terminal at a merchant, it may have physical keys (keys to be pressed). It is then a true keypad comprising keys that are ail identical in appearance to each other. The first grid then consists of a physical keypad.

The locations of the boxes or keys selected successively by the user are recorded and the first terminal 32 checks whether the series of symbols entered by the user is identical to the confidential personal code. If the comparison is positive, the user is authenticated. In the contrary case, the authentication fails and the user may be invited to re-enter his confidential personal code, either by means of the same grid 37 or following the generation of another grid (obtained from another enciphered image).

In the case of a payment by NFC, after authentication of the user at the first terminal 32, he is invited to make a second tap by means of his first terminal 32 on the NFC reader 31 in order to validate the transaction (make the payment). The NFC reader may for this purpose be connected to a banking site 44.

One of the advantages of the solution proposed is that the first and second terminals do not need to be connected: the smartphone 32 can generate the enciphered image without being connected to the network and the smart glasses 33 can decipher the image and display it for the user also without connection.

Where the first terminal 32 is a payment terminal, the user has previously inserted a payment card in a reader associated with the first terminal 32. This first terminal 32 generates an enciphered image 34 comprising all the possible symbols of the confidential personal code of the user (all the symbols 0 to 9 in the case of a code composed of digits). The symbols are mixed and placed in a grid that is enciphered by the key 38. The arrangement of the mixed symbols is transmitted to an application resident in the payment terminal, this application being responsible for making the match between the mixed symbols (presented to the user in the grid 37) and those subsequently entered manually by the user. The enciphered image is deciphered by the second terminal 33 and presented to the user. The latter then sees the second grid “in clear” and successively enters the positions of the symbols of his confidential personal code in a grid (first virtual or physical grid). These successive locations are recorded and transmitted to the aforementioned application. The latter then indicates to the payment card which symbols were successively entered by the user and the card checks whether the symbols selected by the user correspond to those of his confidential personal code. If the authentication is positive, the payment is validated.

The following functioning also applies when the terminal 32 is a banknote dispenser (the comparison is made in the payment/withdrawal card).

The previous example uses a display of an enciphered image but it is also possible to transmit, from the first terminal 32 to the second terminal 33, an out-of-order series of symbols a subset of which constitutes the confidential personal code by a short-distance radio connection, for example Bluetooth, IrDA or NFC or by a local-network connection (for example Wi-Fi). It is also possible to transmit this out-of-order series by optical pulses (flashing light flow). In this case it is not necessary to encipher the out-of-order series of symbols since only the user of the second terminal 13 will be capable of seeing the out-of-order symbols. More generically, the invention therefore consists of:
a. displaying the out-of-order series of symbols in the second grid 37 on a screen of the second terminal 33, each symbol in the series being contained in a box of the second grid 37;
b. the entering, by the user 30 on the first terminal 32, of the confidential personal code in the first grid 39, at the corresponding locations of the symbols of the confidential personal code in the second grid 37;
c. checking, at the first terminal 32 or remote server 50, that the series of symbols entered by the user 30 is identical to the confidential personal code, in order to authenticate the user 30.

In the case of secure access to a remote site, for example to a banking site or a messaging site, the user is invited to authenticate himself with the remote site by entering a code or a password (confidential personal code) in his computer, smartphone or tablet.

The computer, smartphone or tablet then constitutes the first terminal. The remote site generates the enciphered image and transmits it to the user. By means of smart glasses or a smartphone (the second terminal belonging to the user), the image is deciphered and the user successively enters the symbols of his code or password in a virtual grid (smartphone or tablet having a touch screen) or physical grid (computer cooperating with an alphanumeric keyboard), with a view to the arrangement of the symbols of his code or password in the deciphered image. The successive positions of the symbols selected by the user are then transmitted to the remote site, which checks whether the positions of the symbols successively selected by the user correspond to the symbols of the code or password of ht user.

FIG. 4 shows a system where this secure access to a remote site is implemented.

Here a user of a smartphone 32 constituting the first terminal wishes to connect to an internet site 50 of his bank, for example to consult his bank account. A 3G or 4G connection is established between the banking site 50 and the smartphone 32. In order to authenticate the user, the banking site enciphers a grid comprising all the possible symbols of a confidential code by means of the enciphering key 38. These symbols are out of order in the grid. The enciphered grid is transmitted to the user and is displayed on the screen of the smartphone 32. A spy 35 or spyware 51 sees only an enciphered image 52. By means of his second terminal 33 (here smart glasses) comprising the deciphering key 36, a photograph of the enciphered image is taken and a deciphered grid 37 is displayed on the smart glasses 33. The user then enters, in his first terminal 32, in a virtual grid (transparent or white boxes), his confidential personal code. The positions of the symbols of the code are transmitted to the banking site 50, which checks that the positions of the symbols entered by the user in the virtual grid do indeed correspond to the positions of the symbols of the confidential personal code of the user before enciphering of the grid transmitted to this user. If the positions correspond, the user is authenticated.

The spies 35 and 51 see only an enciphered image and successive pressings on certain transparent or white keys but have no knowledge of the code entered by the user in his terminal 32.

The encipherings and decipherings may be based on algorithms based on symmetrical keys (the enciphering key is the same as the deciphering key) or asymmetric keys (the enciphering key is a public key and the deciphering key is a private key).

As before, displaying an enciphered image is not necessary when a radio or infrared communication or a communication by a Wi-Fi network is established between the first and second terminals.

The invention also relates to a first terminal 32, this terminal 32 comprising means for:
a. transmitting, to the second terminal 33 belonging to the user 30, an out-of-order series of symbols a subset of which constitutes a confidential personal code of the user 30;
b. displaying the first virtual grid 39 in which the user 30 can select locations corresponding to locations of symbols displayed in the second grid 37 on the second terminal 33.

The comparison of the code entered by the user with the confidential personal code can be done locally and in this case the first terminal 32 also comprises means for checking that the series of symbols entered by the user 30 in the first virtual grid 39 is identical to the confidential personal code, or remotely, and in this case the first terminal comprises means for transmitting the series of symbols entered by the user 30 in the first virtual grid to the remote server 50.

The invention also relates to a second terminal 33 comprising means for:
a—receiving from a first terminal 32 an out-of-order series of symbols a subset of which constitutes a confidential personal code of the user;
b—displaying on the screen of the second terminal 33 the out-of-order series of symbols in the second grid 37, each symbol in the series being contained in a box of the second grid 37.

Where an enciphered image is used, the terminal 33 further comprises means for deciphering the enciphered image 34 displayed on the screen of the first terminal 32 by means of a camera provided on the second terminal 33 and a deciphering key 36, the enciphered image 34 comprising the out-of-order series of symbols a subset of which constitutes the confidential personal code of the user 30.

The user terminal 33 preferentially consists of smart glasses 33.

Finally, the invention relates to a system for authenticating the user 30 with the first terminal 32 or the remote server 50 connected to the first terminal 32. The system comprises:
means for transmitting, from the first terminal 32 to the second terminal 33, an out-of-order series of symbols a subset of which constitutes the confidential personal code;
means for displaying on the screen of the second terminal 33 the out-of-order series of symbols in the second grid 37, each symbol in the series being contained in a box of the second grid 37;
means for the entering, by the user 30 on the first terminal 32, of the confidential personal code in the first grid 39, at the corresponding locations of the symbols of the confidential personal code in the second grid 37;
means for checking, at the first terminal 32 or remote server 50, that the series of symbols entered by the user 30 is identical to the confidential personal code, in order to authenticate the user 30.

In the case of the user of an enciphered image, the system also comprises:
means for displaying, on the screen cooperating with the first terminal 32, the enciphered image 34 comprising an out-of-order series of symbols a subset of which constitutes the confidential personal code;
means for deciphering, by means of the second terminal 33, the enciphered image 34 by means of a camera provided on the second terminal 33 and a deciphering key 36.

1. A method for authenticating a user with a first terminal or a remote server connected to the first terminal, the authentication comprising the entering of a code in the first terminal by the user and comparing this code with a confidential personal code of the user, said confidential personal code comprising symbols to be entered successively by said user in said first terminal, the method comprising:
a. transmitting from said first terminal to a second terminal belonging to said user an out-of-order series of symbols, a subset of which constitutes said confidential personal code;
b. displaying on a screen of the second terminal said out-of-order series of symbols in a grid, referred to as the second grid, each symbol in said series being contained in a box of said second grid;
c. the entering, by said user on said first terminal, of said confidential personal code in a grid, referred to as the first grid, at the corresponding locations of the symbols of said confidential personal code in said second grid;
d. checking, at said first terminal or said remote server, that the series of symbols entered by said user is identical to said confidential personal code, in order to authenticate said user.

2. A method according to claim 1, wherein:
step -a- comprises a step of displaying on a screen cooperating with said first terminal an enciphered image comprising an out-of-order series of symbols a subset of which constitutes said confidential personal code;
step -b- comprises a step of deciphering, by means of said second terminal, said enciphered image by means of a camera provided on said second terminal and a deciphering key.

3. A method according to claim 1, wherein step -a- comprises a step of transmission, by a short-distance radio connection or a local-network connection, of said out-of-order series of symbols from said first terminal to said second terminal.

4. A method according to claim 2, wherein said enciphered image is a QR code.

5. A method according to claim 1, wherein said second terminal is a smartphone.

6. A method according to claim 1, wherein said second terminal is a pair of smart glasses.

7. A method according to claim 1, wherein said first terminal is a banknote dispenser.

8. A method according to claim 1, wherein the first terminal is a retail sales terminal.

9. A terminal, referred to as the first terminal, this terminal comprising means for:
a. transmitting, to a second terminal belonging to a user, an out-of-order series of symbols, a subset of which constitutes a confidential personal code of the user;
b. displaying a first virtual grid in which said user can select locations corresponding to locations of symbols displayed in a second grid on said second terminal.

10. A terminal according to claim 9, wherein it also comprises means for checking that the series of symbols entered by said user in said first virtual grid is identical to said confidential personal code, in order to authenticate said user.

11. A terminal according to claim 9, wherein it also comprises means for transmitting the series of symbols entered by said user in said first virtual grid to a remote server.

12. A user terminal, referred to as the second terminal, wherein it comprises means for:
a. receiving from a first terminal an out-of-order series of symbols, a subset of which constitutes a confidential personal code of said user;
b. displaying, on a screen of said second terminal, said out-of-order series of symbols in a grid, referred to as the second grid, each symbol in said series being contained in a box of said second grid.

13. A user terminal according to claim 12, wherein it also comprises means for deciphering an enciphered image displayed on a screen of said first terminal by means of a camera provided on said second terminal and a deciphering key, said deciphered image comprising said out-of-order series of symbols a subset of which constitutes the confidential personal code of the user.

14. A user terminal according to claim 12, wherein it comprises smart glasses.

15. A system for authenticating a user with a first terminal or a remote server connected to the first terminal, through authentication comprising the entering of a code in said first terminal by said user and comparing this code with a confidential personal code of said user, said confidential personal code comprising symbols to be entered successively by said user in said first terminal, wherein it comprises:
a. means for transmitting, from said first terminal to a second terminal belonging to said user, an out-of-order series of symbols, a subset of which constitutes said confidential personal code;
b. means for displaying on a screen of said second terminal said out-of-order series of symbols in a grid, referred to as the second grid, each symbol in said series being contained in a box of said second grid;
c. means for the entering, by said user on said first terminal, of said confidential personal code in a grid, referred to as the first grid, at the corresponding locations of the symbols of said confidential personal code in said second grid;
d. means for checking, at said first terminal or remote server, that said series of symbols entered by said user is identical to said confidential personal code, in order to authenticate said user.

16. A system according to claim 15, wherein it also comprises:
a. means for displaying, on a screen cooperating with said first terminal, an enciphered image comprising an out-of-order series of symbols a subset of which constitutes said confidential personal code;
b. means for deciphering, by means of said second terminal, said enciphered image by means of a camera provided on said second terminal and a deciphering key.
